(19) United States
(12) Patent Application Publication
(10) Pub. No.: US 2009/0023568 A1
(43) Pub. Date: Jan. 22, 2009

(54) Joining device for joining plate-like members with through-holes

(75) Inventor: Chih-Hung Hsieh, Chung Ho City (TW)

Correspondence Address: REED SMITH LLP, Suite 1400, 3110 Fairview Park Drive, Falls Church, VA, 22042, US

(73) Assignee: Amtran Technology Co., Ltd.

(21) Appl. No.: 11/898,999

(22) Filed: Sep. 18, 2007

(30) Foreign Application Priority Data
Jul. 18, 2007 (TW) 096211669

(51) Int. Cl. B65D 5/42; B31B 1/60

(52) U.S. Cl. 493/115; 403/321

(57) ABSTRACT

The invention provides a joining device for joining a first plate-like member with a first through-hole and a second plate-like member with a second through-hole. The second plate-like member is disposed adjacent to the first plate-like member such that the first through-hole is aligned with the second through-hole. The joining device includes a frame and a rotatable joining member. The frame has an opening, and as the frame is disposed on the first and the second plate-like members, the opening is aligned with the first and the second through-holes. The rotatable joining member has at least one clipping portion, and is adapted to be disposed in the opening. The rotatable joining member is operable to rotate with an angle such that the at least one clipping portion clips the first and second plate-like members.

### BACKGROUND OF THE INVENTION

1. Field of the Invention

The invention relates to a joining device and, more particularly, to a joining device for joining a first plate-like member with a first through-hole and a second plate-like member with a second through-hole.

2. Description of the Prior Art

Generally, large-scale equipments such as television sets, displaying apparatuses, copy machines, and so on, are usually packaged with inner cartons and outer cartons. Conventionally, when packing large-scale equipment, it is firstly packed in an inner carton. Then, the inner carton is packed inside an outer carton and firmly joined with the outer carton.

Packing strings or packing straps can be used to join an inner carton and an outer carton. But, packing strings or packing straps are easily loosened or broken during transportation, so as to cause damage on the large-scale equipment.

Therefore, a scope of the invention is to provide a joining device for joining plate-like members with through-holes to solve the above problem.

### SUMMARY OF THE INVENTION

A scope of the invention is to provide a joining device for joining a first plate-like member with a first through-hole and a second plate-like member with a second through-hole. The joining device utilizes a rotatable joining member adapted to be disposed in a frame, and the rotatable joining member is operable to rotate with an angle, so as to clip the first and second plate-like members together via at least one clipping portion. Thereby, the joining device of the invention can firmly join the first plate-like member and the second plate-like member. Furthermore, the joining device of the invention is also simple-structured, durable and highly reusable.

The joining device according to an embodiment of the invention is used for joining a first plate-like member with a first through-hole and a second plate-like member with a second through-hole. The second plate-like member is disposed adjacent to the first plate-like member such that the second through-hole is aligned with the first through-hole. The joining device includes a frame and a rotatable joining member. The frame has an opening, and when the frame is disposed on the first plate-like member and the second plate-like member, the opening is aligned with the first through-hole and the second through-hole. The rotatable joining member has at least one clipping portion, and the rotatable joining member is adapted to be disposed in the opening of the frame. The rotatable joining member is operable to rotate with an angle, so as to clip the first and second plate-like members together via the at least one clipping portion.

Therefore, joining device of the invention is used for joining a first plate-like member with a first through-hole and a second plate-like member with a second through-hole. The joining device utilizes a rotatable joining member adapted to be disposed in a frame, and the rotatable joining member is operable to rotate with an angle, so as to clip the first and second plate-like members together via at least one clipping portion. Thereby, the joining device of the invention can firmly join the first plate-like member and the second plate-like member. Furthermore, the joining device of the invention is also simple-structured, durable and highly reusable.

The advantage and spirit of the invention may be understood by the following recitations together with the appended drawings.

### BRIEF DESCRIPTION OF THE APPENDED DRAWINGS

FIG. 1 is an outside view the joining device according to an embodiment of the invention.

FIG. 2 shows the rotatable joining member shown in FIG. 1, as it is disposed in the opening.

FIG. 3 shows the joining device shown in FIG. 1 when it joins the first plate-like member and the second plate-like member.

### DETAILED DESCRIPTION OF THE INVENTION

The invention provides a joining device for joining a first plate-like member with a first through-hole and a second plate-like member with a second through-hole. The joining device utilizes a rotatable joining member adapted to be disposed in a frame, and the rotatable joining member is operable to rotate with an angle, so as to clip the first and second plate-like members together via at least one clipping portion. Thereby, the joining device of the invention can firmly join the first plate-like member and the second plate-like member. Furthermore, the joining device of the invention is also simple-structured, durable and highly reusable. The spirit and feature of the present invention will be described in detail by the following preferred embodiments.

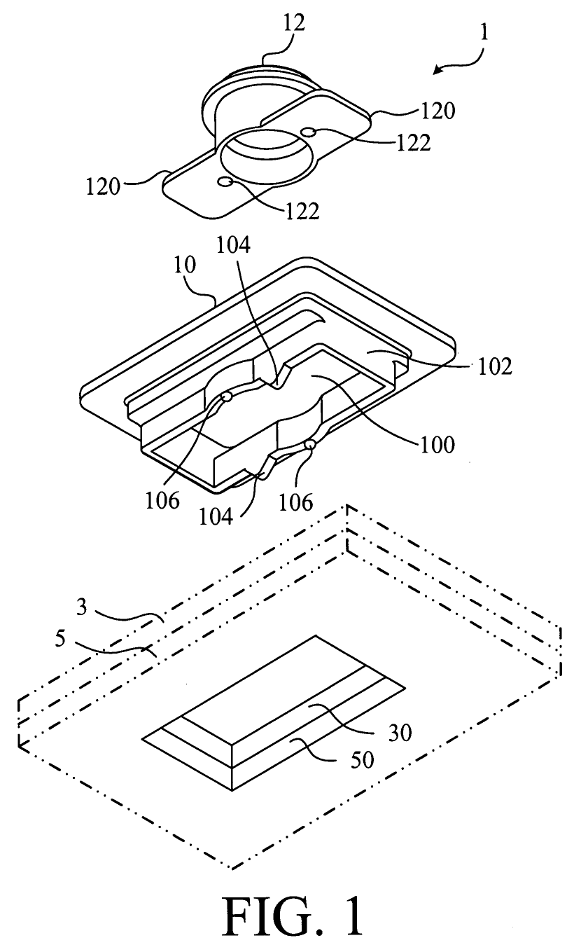

Please Refer to FIG. 1. FIG. 1 is an outside view of the joining device 1 according to an embodiment of the invention. In the embodiment, the joining device 1 is used for joining a first plate-like member 3 with a first through-hole 30 and a second plate-like member 5 with a second through-hole 50, where the second plate-like member 5 is disposed adjacent to the first plate-like member 3 such that the second through-hole 50 is aligned with the first through-hole 30, as shown in FIG. 1. In real applications, the first plate-like member 3 can be a portion of an outer carton (not shown in FIG. 1), and the second plate-like member 5 can be a portion of an inner carton (not shown in FIG. 1) packed inside the outer carton.

As shown in FIG. 1, the joining device 1 includes a frame 10 and a rotatable joining member 12. In real applications, the frame 10 and the rotatable joining member 12 can respectively be, but not limited to, made of plastic or polymer.

The frame 10 has an opening 100, and when the frame 10 is disposed on the first plate-like member 3 and the second plate-like member 5, the opening 100 is aligned with the first through-hole 30 and the second through-hole 50. In applications, the frame 10 can further include a fitting member 102 adapted to be fitted into the first through-hole 30 and the second through-hole 50.

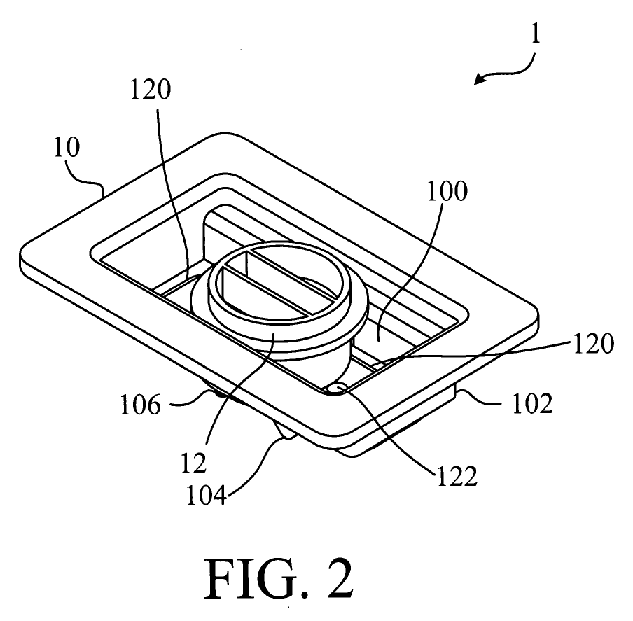

Please refer to FIG. 2. FIG. 2 shows the rotatable joining member 12 shown in FIG. 1 as it is disposed in the opening. The rotatable joining member 12 has at least one clipping portion 120. The rotatable joining member 12 is adapted to be disposed in the opening 100.

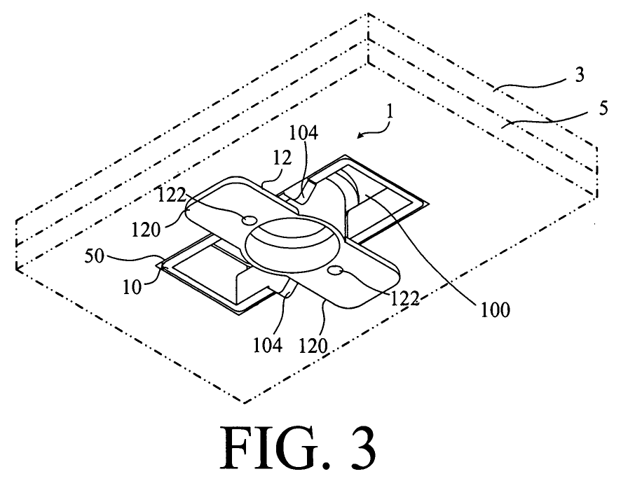

Please refer to FIG. 3. FIG. 3 shows the joining device 1 shown in FIG. 1 when it joins the first plate-like member 3 and the second plate-like member 5. As shown in FIG. 3, the rotatable joining member 12 is operable to rotate with an angle, so as to clip the first plate-like member 3 and second plate-like member 5 together via the at least one clipping portion 120. Thereby, the joining device can join the first plate-like member 3 and second plate-like member 5.

In real applications, the frame 10 can further include at least one protruding portion 104 capable of elastically deforming the at least one clipping portion 120 during the rotation of the rotatable joining member 12. Thereby, the at least one clipping portion 120 can move to a desired position without being interfered by the second plate-like member 5 during the rotation of the rotatable joining member 12.

In real applications, frame 10 can further include at least one boss 106, and the rotatable joining member 12 can further include at least one recess 122, as shown in FIG. 1. Each boss 106 and each recess 122 can constitute a pair of engaging portions. After the rotatable joining member 12 rotates with the angle to join the first plate-like member 3 and the second plate-like member 5, the at least one pair of engaging portions fixes the rotatable joining member 12 relative to the frame 10. Thereby, the rotatable joining member 12 will not be easily rotated so that the joining device 1 can join the plate-like member 3 and the second plate-like member 5 more firmly. It is noticeable that the pair of engaging portions can also consist of a recess disposed on the frame 10 and a boss disposed on the rotatable joining member 12.

The joining device of the invention is used for joining a first plate-like member with a first through-hole and a second plate-like member with a second through-hole. The joining device utilizes a rotatable joining member adapted to be disposed in a frame, and the rotatable joining member is operable to rotate with an angle, so as to clip the first and second plate-like members together via at least one clipping portion. Thereby, the joining device of the invention can firmly join the first plate-like member and the second plate-like member. Furthermore, the joining device of the invention is also simple-structured, durable and highly reusable.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A joining device for joining a first plate-like member with a first through-hole and a second plate-like member with a second through-hole, the second plate-like member being disposed adjacent to the first plate-like member such that the second through-hole is aligned with the first through-hole, said joining device comprising:
a frame having a opening, when the frame is disposed on the first plate-like member and the second plate-like member, the opening being aligned with the first through-hole and the second through-hole; and
a rotatable joining member having at least one clipping portion, the rotatable joining member being adapted to be disposed in the opening, the rotatable joining member being operable to rotate with an angle, so as to clip the first and second plate-like members together via the at least one clipping portion.

2. The joining device of claim 1, wherein the frame further comprises at least one protruding portion capable of elastically deforming the at least one clipping portion during the rotation of the rotatable joining member.

3. The joining device of claim 1, wherein the frame and the rotatable joining member further comprises at least one pair of engaging portions such that after the rotatable joining member rotates with the angle, the at least one pair of engaging portions fixes the rotatable joining member relative to the frame.

4. The joining device of claim 3, wherein each of the at least one pair of engaging portions comprises a boss disposed on the frame and a recess disposed on the rotatable joining member.

5. The joining device of claim 3, wherein each of the at least one pair of engaging portions comprises a recess disposed on the frame and a boss disposed on the rotatable joining member.

6. The joining device of claim 1, wherein the frame is made of plastic or polymer.

7. The joining device of claim 1, wherein the rotatable joining member is made of plastic or polymer.

8. The joining device of claim 1, wherein the first plate-like member is a portion of an outer carton, and the second plate-like member is a portion of an inner carton packed inside the outer carton.
